(19) United States
(12) Patent Application Publication
(10) Pub. No.: US 2013/0094111 A1
(43) Pub. Date: Apr. 18, 2013

(54) ELECTRICAL SURGE PROTECTOR AND METHOD OF PROVIDING THE SAME

(71) Applicant: Belkin International, Inc., Playa Vista, CA (US)

(72) Inventors: Jeffrey W. Garb, West Hills, CA (US); Pedro Manrique, Pasadena, CA (US); Philip Mathew Hodgson, Wadalba (AU)

(73) Assignee: BELKIN INTERNATIONAL, INC., Playa Vista, CA (US)

(21) Appl. No.: 13/708,596

(22) Filed: Dec. 7, 2012

Related U.S. Application Data
(63) Continuation of application No. PCT/US2011/039684, filed on Jun. 8, 2011.
Application No. PCT/US2011/039684 is a continuation-in-part of application No. 13/021,706, filed on Feb. 4, 2011.
Application No. PCT/US2011/039684 is a continuation-in-part of application No. 12/428,468, filed on Apr. 22, 2009, now Pat. No. 8,232,683.
Application No. 12/428,468 is a continuation-in-part of application No. 13/021,706, filed on Feb. 4, 2011.
(60) Provisional application No. 61/301,471, filed on Feb. 4, 2010.
(60) Provisional application No. 61/047,070, filed on Apr. 22, 2008.
(60) Provisional application No. 61/155,468, filed on Feb. 25, 2009.
(60) Provisional application No. 61/352,803, filed on Jun. 8, 2010.
(60) Provisional application No. 61/301,471, filed on Feb. 4, 2010.

(51) Int. Cl. H02H 9/04; G05F 5/00

(52) U.S. Cl. CPC H02H 9/04; G05F 5/00
USPC 361/18; 323/299

(57) ABSTRACT

Some embodiments include an electrical surge protector. Other embodiments of related systems and methods are also disclosed.

### CROSS-REFERENCE TO RELATED APPLICATIONS

This patent application is (a) a continuation of International Patent Application Serial No. PCT/US2011/039684, filed Jun. 8, 2011, and (b) a continuation-in-part of U.S. patent application Ser. No. 13/021,706, filed Feb. 4, 2011, which claims the benefit of U.S. Provisional Patent Application No. 61/301,471, filed on Feb. 4, 2010.

International Patent Application Serial No. PCT/US2011/039684 is a continuation-in-part application of U.S. patent application Ser. No. 13/021,706. International Patent Application Serial No. PCT/US2011/039684 is also a continuation-in-part application of U.S. patent application Ser. No. 12/428,468, filed Apr. 22, 2009, which claims the benefit of U.S. Provisional Patent Application No. 61/047,070, filed on Apr. 22, 2008, and U.S. Provisional Patent Application No. 61/155,468, filed on Feb. 25, 2009.

Meanwhile, International Patent Application Serial No. PCT/US2011/039684 also claims the benefit of U.S. Provisional Patent Application No. 61/352,803, filed on Jun. 8, 2010.

International Patent Application Serial No. PCT/US2011/039684, U.S. patent application Ser. No. 13/021,706, U.S. patent application Ser. No. 12/428,468, U.S. Provisional Application No. 61/047,070, U.S. Provisional Application No. 61/155,468, U.S. Provisional Application No. 61/301,471, and U.S. Provisional Application No. 61/352,803 are incorporated by reference herein in their entirety.

### FIELD OF THE INVENTION

Subject matter described herein relates to power supply devices, and more particularly to power strips.

### DESCRIPTION OF THE BACKGROUND

Electronic devices of all types have become more and more common in everyday life. Electronic devices include non-portable devices as well as portable devices. Examples of non-portable electronic devices include computing devices (e.g., personal computers, etc.), wired telephones, routers (wired and wireless), wireless access points (WAPs), televisions, most large and small kitchen appliances, and the like. Examples of portable electronic devices include cellular phones, laptops, personal data assistants (PDAs), combination cellular phone and PDAs (e.g., a Blackberry® device available from Research in Motion (RIM®) of Ontario, Canada), cellular phone accessories (e.g., a Bluetooth® enabled wireless headset), MP3 (Moving Pictures Experts Group-1 Audio Layer 3) players (e.g., an iPod® device by Apple Inc. (Apple®) of Cupertino, Calif.), compact disc (CD) players, and digital video disk (DVD) players. Along with the positive benefits of use of such devices comes the requirement to power the devices.

Typically, users utilize power distribution devices (e.g., power strips, also called relocatable power taps) to provide power to operate or charge one or more of the aforementioned electronic devices as well as numerous other electronic devices. These power distribution devices typically include a power supply that provides power to one or more outlets. The power supplies for such power distribution devices may or may not incorporate surge protection or protection from other types of anomalies in the electrical power from the external source.

Accordingly, a need exists for an electrical device that provides protection for various types of anomalies in the electrical power from the external source.

### BRIEF DESCRIPTION OF THE DRAWINGS

To facilitate further description of the embodiments, the following drawings are provided in which:

FIG. 1 illustrates an exemplary electrical device, according to a first embodiment;

FIG. 2 illustrates a circuit diagram of a first portion of the electrical device of FIG. 1, according to the first embodiment;

FIG. 3 illustrates a circuit diagram of a second portion of the electrical device of FIG. 1, according to the first embodiment;

FIG. 4 illustrates a flow chart for an embodiment of a method of providing an electrical device, according to the first embodiment;

FIG. 5 illustrates a flow chart for an embodiment of an activity of providing a power supply, according to the first embodiment; and

FIG. 6 illustrates a flow chart for an embodiment of an activity of providing a protection circuit, according to the first embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In some embodiments, an electrical device can include: (a) an electrical power input configured to receive an input electrical power signal, the input electrical power signal includes a reference power line signal; (b) a power supply configured to output at least two output electrical power signals, the at least two output electrical power signals are referenced to the reference power line signal. The power supply can be devoid of a transformer. The power supply can be further devoid of a switch. The power supply can be configured to derive the at least two output electrical power signals from the input electrical power signal by using capacitive reactance to limit a current of the input electrical power signal.

In other embodiments, a relocatable power tap can include: (a) an electrical power connector configured to receive an alternating current input power signal from an external power source, the alternating current input power signal comprises an L1 line signal and an L2 line signal; (b) a power supply configured to provide at least two direct current electrical power signals derived from the alternating current input power signal and referenced to the L2 line signal when the electrical power connector receives the alternating current input power signal from the external power source; (c) a control circuit; (d) an active voltage rectifier; (e) an active current rectifier; and (f) a protection circuit. The active voltage rectifier and the active current rectifier can be configured to produce two or more first output signals and provide the two or more first output signals to the control circuit. The control circuit can be configured to determine one or more parameters of the alternating current input power signal based on the two or more first output signals. The control circuit can be further configured to control the protection circuit based on the one or more parameters.

In still further embodiments, a method of providing an electrical device can include: providing an electrical power connector configured to receive an alternating current input power signal from an external power source, the alternating current input power signal comprises an L1 line signal and an L2 line signal; providing a power supply configured to supply at least two direct current electrical power signals derived from the alternating current input power signal and referenced to the L2 line signal when the electrical power connector receives the alternating current input power signal from the external power source; coupling the power supply to at least one output of the electrical power connector; providing a control circuit; providing an active voltage rectifier; coupling the active voltage rectifier to a first input of the control circuit such that the active voltage rectifier can provide a first output signal to the first input of the control circuit; providing an active current rectifier; coupling the active current rectifier to a second input of the control circuit such that the active current rectifier can provide a second output signal to the second input of the control circuit; providing a protection circuit; and coupling the control circuit to the protection circuit. The control circuit can be configured to determine one or more parameters of the alternating current input power signal based on the first output signal and the second output signal. The control circuit can be further configured to control the protection circuit based on the one or more parameters. The power supply can be configured to provide each of the at least two direct current electrical power signals to at least one of the control circuit, the active voltage rectifier, the active current rectifier or the protection circuit.

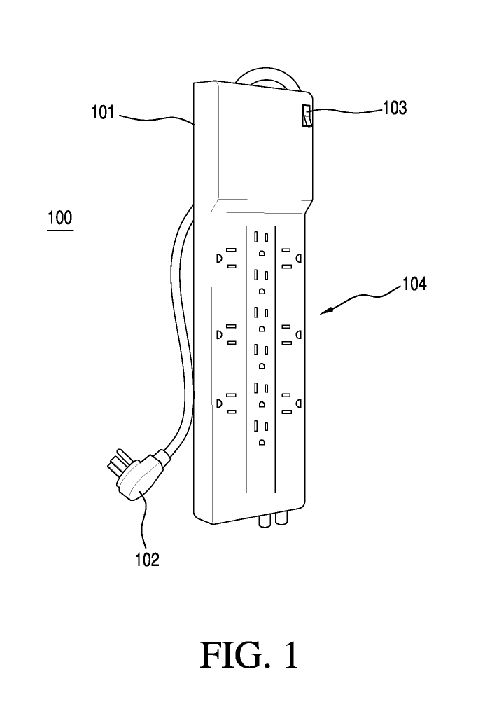

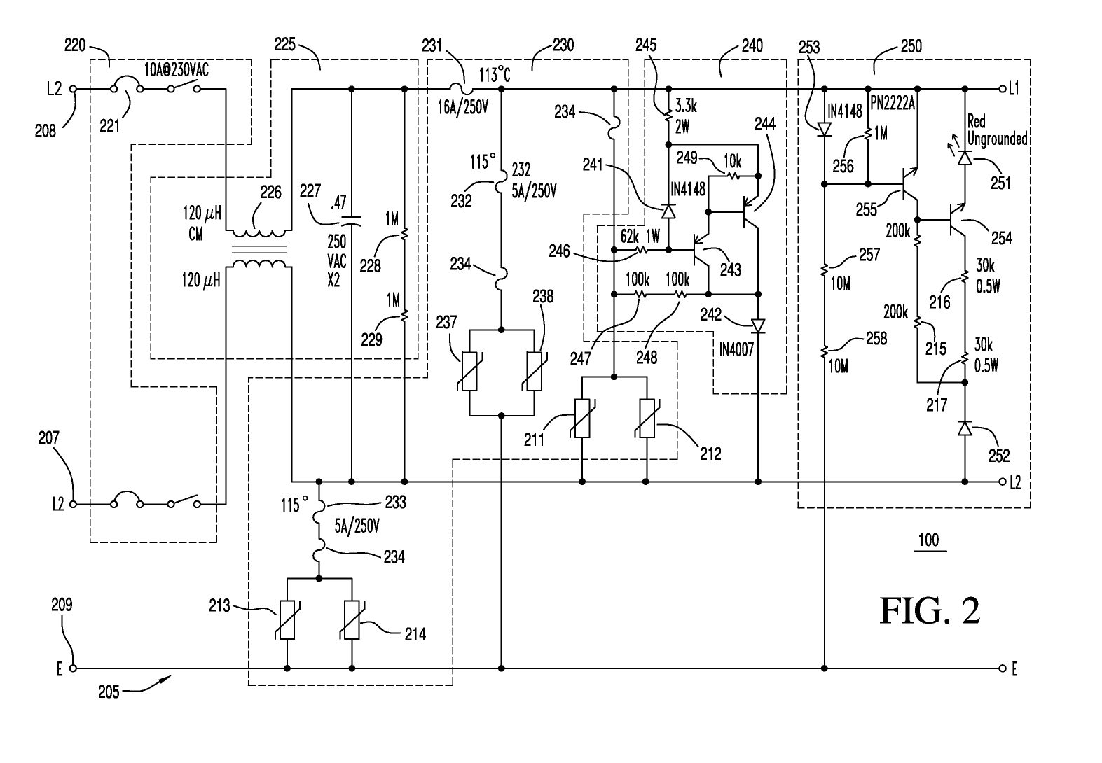

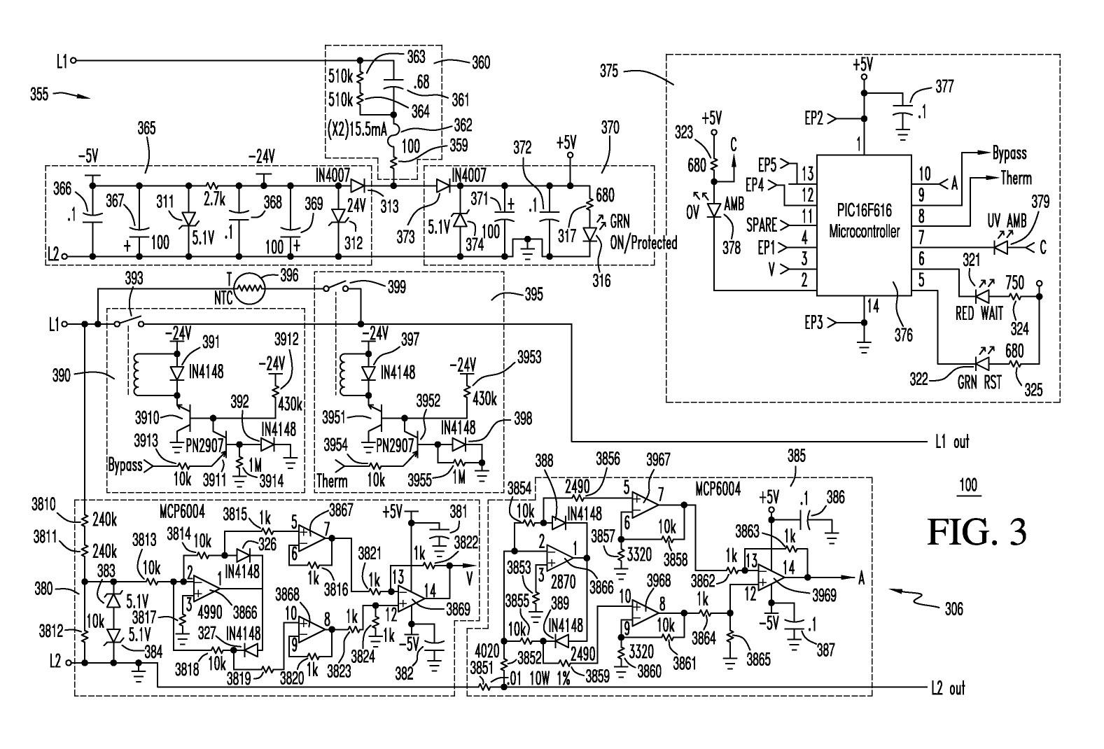

FIG. 1 illustrates an exemplary electrical device 100, according to a first embodiment; FIG. 2 illustrates a circuit diagram of a first portion of electrical device 100, according to the first embodiment; AND FIG. 3 illustrates a circuit diagram of a second portion of electrical device 100, according to the first embodiment. Electrical device 100 is merely exemplary, and the scope of the invention is not limited to the embodiments presented herein. Electrical device 100 can be employed in many different embodiments or examples not specifically depicted or described herein.

In general, electrical device 100 can include features such as a universal ground detection circuit, an enhanced EMI/RFI (electromagnetic interference/radio frequency interference) filter circuit, and a simple, efficient, and inexpensive DC (direct current) power supply. Electrical device 100 can also switch at zero crossing, which can help extend the operational life of electrical device 100. The protection features in electrical device 100 can include one or more of a voltage surge protection, a circuit to disable electrical device 100 on failure of the main surge protection, over voltage protection, under voltage protection, inrush current protection, and over current protection.

In some examples, electrical device 100 can include one or more of the following circuits: a loss of surge protection shutdown circuit, a universal ground detection circuit, the power supply circuit, and two full wave active rectifier circuits. In the same or different examples, electrical device 100 can include the feature that over voltage and over current can be detected and interrupted in one half cycles or less, and the same can be true for under voltage.

Electrical device 100 can also include a loss of surge protection shutdown circuit. Other power distribution devices typically contain little or no active circuitry, and other power outlet strips do not actively shutdown if a MOV (Metal Oxide Varistor) (e.g., MOV 211, 212, 213, 214, 237, 238 of FIG. 2) or surge protection is lost.

As will be described below in detail, electrical device 100 can also include a universal ground detection circuit. The configuration of the grounding or earthing conductors (E) varies greatly from country to country. The circuitry in electrical device 100 accommodates the variations between countries.

In some embodiments, electrical device 100 can also include a power supply circuit. The power supply circuit can be a simple, efficient, and inexpensive DC (direct current) power supply. It supplies three low DC voltages, two negative and one positive, all referenced directly to one of the power lines (e.g., the neutral line L2) from the AC (alternating current) line voltage. The power supply circuit can be transformer-less and switch-less and can use only one capacitively reactive element (e.g., a capacitor) to reduce the electrical power from line power levels to circuit level power. Not using a transformer or a switch can reduce the cost and complexity of electrical device 100. Another feature of this power supply can be its reference of its ground to one of the power lines. Measuring parameters from the power line can allow simplification of the design of the circuits of electrical device 100.

In some embodiments, electrical device 100 can also include an active full wave rectifier. In some examples, electrical device 100 can include two active full wave rectifiers. One of the two active full wave rectifiers can be used to measure the line voltage parameter, and the other of the two active full wave rectifiers can be used to measure the line current parameter. Using two active full wave rectifiers, many parameters can be accurately and easily measured from the line. Zero crossing of either current or voltage, phase angle of voltage and current, peak, average, and RMS (root mean square) values of either voltage and/or current are but a few parameters that can be readily captured by the combination of these two circuits. The design of the rectifier circuits are simplified and the accuracy improved because the ground node of these circuits and the line voltage are at the same reference point.

In some embodiments, electrical device 100 can also include a microcontroller. In some examples, the microcontroller can provide almost instantaneous detection of fault currents and other faults and the immediate or almost immediate shutdown of electrical power. In some examples, this feature can also be implemented at the zero crossing point. Also, the turning on of electrical power can be made to happen at or near zero crossing. As previously mentioned, this feature can help prolong the life of electrical device 100.

Referring to FIG. 1, in some examples, electrical device 100 can be a power strip (also called a surge protector or a relocatable power tap (RPT)). Electrical device 100 can include an enclosure 101 and power plug 102 (i.e., an electrical power connector). Enclosure 101 includes indicator interface 103 and power receptacle array 104 (i.e., one or more female electrical power connectors) as well as other circuitry detailed below in relation to FIGS. 2-3. In one embodiment, indicator interface 103 includes one or more light emitting diodes (LEDs) to communicate its ground and power status to a user. In some embodiments, enclosure 101 additionally includes protection circuitry. Power strip circuitry including protection circuitry and universal ground detect circuitry is described below in relation to FIGS. 2-4. Electrical device 100 may include additional elements not relevant to the present discussion.

In operation, when power plug 102 is operably coupled to and in electrical communication with an appropriate external power source (e.g., an AC or other power outlet fixture), electrical power becomes available to components within enclosure 101.

In some examples, electrical device 100 can be an electrical surge protected outlet strip with additional features and protection. Various embodiments of electrical device 100 can be designed for use in Australia where the line voltage is 230 VAC (Volts Alternating Current) at 50 Hz (Hertz) and where the current protection is 10 amps. In other examples, electrical device 100 can be designed for use in the United States where the line voltage is 240 VAC at 60 Hz and where the current protection is 10 amps. Still other embodiments can be adapted for other countries, voltages, and currents.

Referring to FIGS. 2 and 3, in some embodiments, electrical device 100 can include: (a) an input protection circuitry 205 (FIG. 2); and (b) internal extra protection circuitry 306 (FIG. 3). In various embodiments, electrical power can be applied to input protection circuitry 205 at nodes 207, 208, and 209.

Referring to FIG. 2, input protection circuitry 205 can include: (a) over-current protection circuit 220; (b) EMI/RFI circuit 225; (c) surge protection circuit 230; (d) a crowbar circuit 240, which can disable electrical device 100 in the event surge protection is lost; and (e) a universal ground detection circuit 250, or any combination thereof.

Referring to FIG. 3, internal extra protection circuitry 306 can include six circuits or blocks, some of which are the same. That is, internal extra protection circuitry 306 can include: (a) power supply 355; (b) a control circuit 375 (e.g., a microcontroller and indicator LEDs (light emitting diode)); (c) a bypass circuit 390 (e.g., a bypass relay driver and relay); (d) a thermistor circuit 395 (e.g., a thermistor relay driver and relay); (e) an active voltage rectifier 380; and (f) an active current rectifier 385, or any combination thereof.

Returning to FIG. 2, over-current protection circuit 220 can include either a single or double pole circuit breaker 221. The purpose of over-current protection circuit 220, if all else fails, is to protect any device coupled to electrical device 100 and, possibly, electrical device 100 itself from extreme over-current. Over-current protection circuit 220 should rarely if ever need to be used as the internal circuits should provide this protection most of the time.

EMI/RFI circuit 225 can include: (a) transformer 226; (b) capacitor 227; and (c) resistors 228 and 229. EMI/RFI circuit 225 can reduce conducted and some radiated RF (radio frequency electromagnetic radiation) entering electronic devices plugged into electrical device 100, and also reduces any RF energy coming out of those devices from entering the general wiring of the home or business and contaminating other devices.

Surge protection circuit 230, or short duration voltage surge block, can include: (a) thermal cutoffs 231, 232, 233; (b) MOVs 237, 238, 211, 212, 213, 214; and (c) trace fuses or wire jumper fuses 234.

Crowbar circuit 240 can include: (a) diodes 241 and 242; (b) transistors 243 and 244; and (c) resistors 245, 246, 247, 248, and 249. In some examples, the purpose of crowbar circuit 240 can be to sense a failure in the main MOV circuit (MOVs across the main power lines) and kill electrical device 100 if a fault is detected.

Universal ground detection circuit 250 can include: (a) diodes 251, 252, and 253; (b) transistors 254 and 255; and resistors 215, 216, 217, 256, 257, 258, and 259. In many countries, the ground (or earth) is not always related to the neutral line as it is in the United States. In an embodiment compatible with standard United States wiring practices, conventions, and standards, neutral is used as a reference, and ground is compared against neutral. If ground is present, no current flows into the transistor from its bias resistor because it all flows to ground and thus the transistor does not conduct and a fault is not indicated. For some applications outside the United States, this method will not work because, depending on the country, the ground could be at neutral (or L2), or it could be in the center between L1 and neutral (or L2). Universal ground detection circuit 250 does not use neutral as a reference. Instead, universal ground detection circuit 250 can be configured to find a third wire. If the third wire is present, then transistor 255 can conduct and causes transistor 254 not to conduct, thus not causing a fault indication.

Referring to FIG. 3, power supply 355 can include: (a) a supply input section 360; (b) a negative power section 365; and (c) a positive power section 370, or any combination thereof. Supply input section 360 can include: (a) capacitor 361; (b) fuse 362; and (c) resistors 359, 363, and 364. Negative power section 365 can include: (a) capacitors 366, 367, 368, 369; (b) diodes 311, 312, and 313; and (c) resistor 314. Positive power section 370 can include: (a) capacitor 371 and 372; (b) diodes 316, 373, and 374; and (c) resistor 317.

In some embodiments, power supply 355 can be a three voltage DC supply derived from the AC electrical line using the capacitive reactance to limit the current, which reduces line voltage to that required by the internal circuits. Power supply 355 can supply +5 VDC to control circuit 375, and to the positive supply of active voltage rectifier 380 and active current rectifier 385. It also supplies −5 VDC to the negative supply of active voltage rectifier 380 and active current rectifier 385 and −24 VDC to the relays. The positive and negative loads can be substantially balanced. This balance helps increase the efficiency of power supply 355.

In the illustrated embodiment, capacitor 361 and all other components, except for resistors 363 and 364, form a voltage divider with a reactive input to the power line (e.g., L1). Capacitor 361 forms the top resistance or in this case, reactance, and everything else forms the bottom resistance. Because capacitor 361 can be a relatively high reactance, it appears more like a constant current source to the rest of the power supply. Resistors 363 and 364 are configured to bleed voltage off of capacitor 361 when power is off to prevent accidentally shocking the user. Fuse 362 provides protection in the event of a short anywhere in the supply or load, and resistor 359 can be used for inrush current and some surge protection. Diodes 313 and 373 provide a path for both the positive and negative half cycle of the AC voltage. This configuration allows capacitor 361 to continue to supply current; it also allows the DC voltages to be referenced to one of the incoming AC lines (e.g., L2). Diodes 312 and 374 are both zener diodes and limit the voltages to −24 VDC and +5 VDC respectively. The capacitors 368, 369, 371, and 372, which immediately follow the zener diodes, store and help smooth the pulsating DC and turn it into a relatively smooth DC. The +5 VDC supply is finished, except that there can be an diode 316 (i.e., an LED) and resistor 317 used as an indicator for both power on and protected status. The +5 VDC has as much coming out of it as the −24 VDC. About 4 mA (milliamps) of current is supplied to the op amps (e.g., op amps 3866, 3867, 3868, 3869, 3866, 3867, 3868, and 3869) in the active rectifiers 380 and 385, and about a milliamp is supplied to microcontroller 376 for housekeeping and to drive the relay driver circuits. All the rest, about 11 mA, is used to drive the LED indicators. The −24 VDC supply supplies power to the relays and goes on, through resistor 314, to make the −5 VDC supply. Diode 311 can be a 5 volt zener diode and is used to shunt regulate the 5 VDC supply in some examples. It can be followed by capacitors 366 and 367, which smooth the −5 volt. Power supply 355 can be used to power the negative power input to the op amps (e.g., op amps 3866, 3867, 3868, 3869, 3866, 3867, 3868, and 3869) in the active rectifiers 380 and 385.

In this particular embodiment, control circuit 375 can include: (a) capacitor 377; (b) diodes 321, 322, 378, and 379; (c) microcontroller 376; and (d) resistors 323, 324, and 325. Control circuit 375 can indicate to the user the status of the power line and what the user should do to interface with electrical device 100. It also controls the relays based on what the line is doing. In some examples, control circuit 375 can include diode 325 (e.g., a green diode). In other examples, control circuit 375 does not include diode 325.

Active voltage rectifier 380 can include: (a) capacitors 381 and 382; (b) diodes 326, 327, 383, and 384; (c) op amps 3866, 3867, 3868, and 3869; and (d) resistors 3810-3824. Active current rectifier 385 can include: (a) capacitors 386 and 387; (b) diodes 388 and 389; (c) op amps 3966, 3967, 3968, and 3969; and (d) resistors 3851-3865.

Active voltage rectifier 380 and active current rectifier 385 can be configured to turn the measured parameters from a high power AC signal to a high fidelity low power scaled DC signal. This output signal can be then fed to the analog to digital convertor in the microcontroller so that the microcontroller can make decisions based on the status of these measured parameters. These parameters include but are not limited to the following: zero voltage and current crossing, peak, RMS, and average voltage and current, phase angle of voltage to current, and crest factor. All or some of these parameters can be used by the microcontroller.

Active voltage rectifier 380 and active current rectifier 385 can be similar in some examples. In some embodiments, active voltage rectifier 380 and active current rectifier 385 can be identical circuits except for their gain and the type of signal that they capture (voltage and current). The voltage circuit will be discussed, as representative of both active rectifier circuits. Then the differences between active voltage rectifier 380 and active current rectifier 385 will be discussed.

In general, the active full wave rectifier circuits can include an IC (integrated circuit) that has four sections. Each section can have an identical op amp, called a quad op amp (e.g., op amps 3866, 3867, 3868, and 3869). Around the IC are two rectifier diodes, some resistors, and some decoupling capacitors. Most of the work in terms of fidelity and rectification can be done in the first section of the quad op amp.

The first section may be set up as either an inverting or non-inverting amplifier. The non-inverting configuration has higher input impedance, but can have some drawbacks. In this embodiment shown in FIG. 3, the inverting configuration can be used. Section A (e.g., the circuitry associated with op amp 3866) can be setup as a standard inverting, unity gain, ground referenced amplifier in some examples. Resistor 3817 references op amp 3866 to ground and can be calculated to balance offset currents. Resistor 3813 can be the input resistor, and resistor 3814 can be the feedback resistor. In addition, resistor 3818 can be a second feedback resistor. In series with each of feedback resistors 3814 and 3818 can be feedback diodes 326 and 327, respectively. Diodes 326 and 327 can be in opposite polarity to each other. When a positive voltage is present at the input to resistor 3813, the output of the op amp 3866 swings to the negative. This back biases diode 327, turning it off and not allowing that feedback path to be used. Diode 326, however, can be forward biased and forms the feedback loop for positive input voltages. Op amp 3866 drives diode 326 on the positive half cycle such that the junction between diode 326 and resistor 3814 exactly match the input voltage, but opposite in polarity. The advantage here is that diode 326 has a non-linear response, and the action of op amp 3866 linearizes the response at the junction of diode 326 and resistor 3814.

In the Section B (e.g., the circuitry associated with op amp 3867), resistor 3815 and resistor 3816 act as an impedance buffer for the junction of diode 326 and resistor 3815 and send the inverted signal to the inverting input of section D (e.g., the circuitry associated with op amp 3869). In Section C (e.g., the circuitry associated with op amp 3868), resistor 3819 and resistor 3820 perform the same function for the junction between diode 327 and resistor 3818, and send the non-inverted signal to the non-inverting input of the op amp 3869. Section D (e.g., the circuitry associated with op amp 3869) can be configured using resistors 3821-3824 as a differential amp and takes the inverted signal and non-inverted signal and combines the two signals into a non-inverted train of half cycle pulses, so that the output can be pulsating DC.

Active current rectifier 385 can be substantially similar to active voltage rectifier 380, except for gain and signal source. In active voltage rectifier 380, the overall gain can be unity, for example. In active current rectifier 385, the gain can be 10, for example. The gain can be distributed over the first two stages. The input stage has a gain of 2.5, and the buffer stage has a gain of four. The gain can be split up so that offset errors generated by the first stage are minimized. This is not necessary for active voltage rectifier 380 because the gain can be unity for active voltage rectifier 380, and the signal level can be much greater compared to the offset error.

Second, the signal source can be different for each of active voltage rectifier 380 and active current rectifier 385. For active voltage rectifier 380, the signal comes from across the line, reduced in amplitude by the voltage divider created by resistors 3810, 3811, and 3812 and the input impedance of the active voltage full wave rectifier circuit's resistor 3813 in parallel with resistor 3812. Diodes 383 and 384 are used for over voltage protection. For active current rectifier 385, the signal comes from a shunt resistor 3851. Current flowing to the load flows through resistor 3851 and generates a voltage directly proportional to the current flow. In some examples, shunt resistor 3851 can have a very low value resistor so that it produces much less than 0.5V in normal use and also dissipates very little power.

In many embodiments, a 0.01 ohm resistor can be used as shunt resistor 3851. Shunt resistor 3851 produces, for a normal maximum current flow of 10 A, only 0.1V across the shunt at 1 W. However, at a fault current of 40 A, 0.4 volts are generated across the shunt (still quite low), but the power dissipated for a short time can be 16 W, for example. Because shunt resistor 3851 can be such a low value resistor, it only generates an output of 10 mV/Amp. For this reason, active current rectifier 385 has a gain of 10 to get values into the analog to digital converter that are useful. Resistor 3852 picks up this voltage signal for the current circuit, and the process can be the same as it is in active voltage rectifier 380 from resistor 3813, except for gain differences.

Bypass circuit 390 can include: (a) diode 391 and 392; (b) relay 393; (c) transistors 3910 and 3911; and (d) resistors 3912-3914. Thermistor circuit 395 can include: (a) negative temperature coefficient (NTC) thermistor 396; (b) diodes 397 and 398; (c) relay 399; (d) transistors 3951 and 3952; and (e) resistors 3953-3955.

In various examples, bypass circuit 390 and thermistor circuit 395 can be similar. They both have the same driver circuit and relay, but relays 393 and 399 have two different functions. Bypass circuit 390 can be configured to allow microcontroller 376 with positive output voltages to control relays, which are powered from a negative supply. Thermistor circuit 395 can be configured to turn on at zero voltage crossing and at power on. If current is detected, bypass relay 393 will after a short delay bypass thermistor 396 and thermistor relay 399 will open. If current drops below a very low value, the thermistor relay 399 will again engage and the bypass relay 393 will open. Relays 393 and 399 open during fault conditions of over voltage or current, and under voltage. However, an inrush current of up to three times the normal current will allow thermistor relay 399 to remain closed. If this current level is sustained for a time period (e.g., 20-30 or 100 milliseconds), it will be considered an over current and relays 393 and 399 will open. Any level above the normal maximum current will be considered a fault current based on the length of time it is present. If the current level equals or exceeds four times the normal current for any length of time, it will be considered a fault current immediately and relays 393 and 399 will open immediately. Accordingly, electrical device 100 provides two fault mechanisms in case a fault current: (1) over-current protection circuit 220; and (2) the method described above using bypass circuit 390 and thermistor circuit 395.

The detailed electrical description that follows can be based on only three circuit variations in the internal protection circuitry. It will cover five circuit sections, but two of the circuit sections are similar to two other circuit sections, and those sections will be covered in the main three circuit analysis. The other circuits in the input protection circuit section and one in the internal protection circuit section will not be discussed here.

Bypass circuit 390 can supply electrical power directly to the load, bypassing thermistor circuit 395. Thermistor circuit 395 can supply electrical power to the load through NTC thermistor 396. When there is no current flowing, relay 399 is on, putting the NTC thermistor 396 in series with the load. At this time, NTC thermistor 396 can be cold (room temperature) and it has a high resistance, (e.g., ten ohms) As current flows, NTC thermistor 396 gets hot and its resistance can drop down to, for example, a few fractional ohms At this time, bypass circuit 390 will be turned on and bypasses thermistor circuit 395, which is allowed to cool down. This action mitigates any inrush current and allows the NTC thermistor 396 to be used for the next instance of inrush current.

Bypass circuit 390 will be described herein. In various examples, thermistor circuit 395 can be identical or similar to bypass circuit 390 (except for thermistor 396). Relay 393 can be a 15 amp at 240 VAC, 24 VDC coil, SPST (single pole, single throw), NO, relay. For example, diode 391 can be used to absorb counter EMF when the relay coil is switched off Transistor 3910 can be the switching transistor for the relay 393. Relay 393 is biased off by resistor 3912. When transistor 3911 is biased on, transistor 3911 overcomes resistor 3912 and turns on transistor 3910, thus switching the relay 393 on. The emitter of transistor 3911 can be coupled through the current limiting resistor 3913 to an output pin of microcontroller 376. When microcontroller 376 output is low, the emitter of transistor 3911 is pulled close to ground. Because the base of transistor 3911 is held near ground by resistor 3914 and any collector leakage current is shunted to ground by resistor 3914, transistor 3911 is biased off and relay 393 is off When resistor 3913 is pulled high by an output pin of microcontroller 376, current flows from the output pin through resistor 3913, the emitter-base junction of transistor 3911, and diode 392 to ground turning transistor 3911 and thus relay 393 on. Diode 392 is present to insure that at least a one volt margin is required to turn transistor 3911 on. At least a portion of thermistor circuit 395 can function in exactly the same or similar manner.

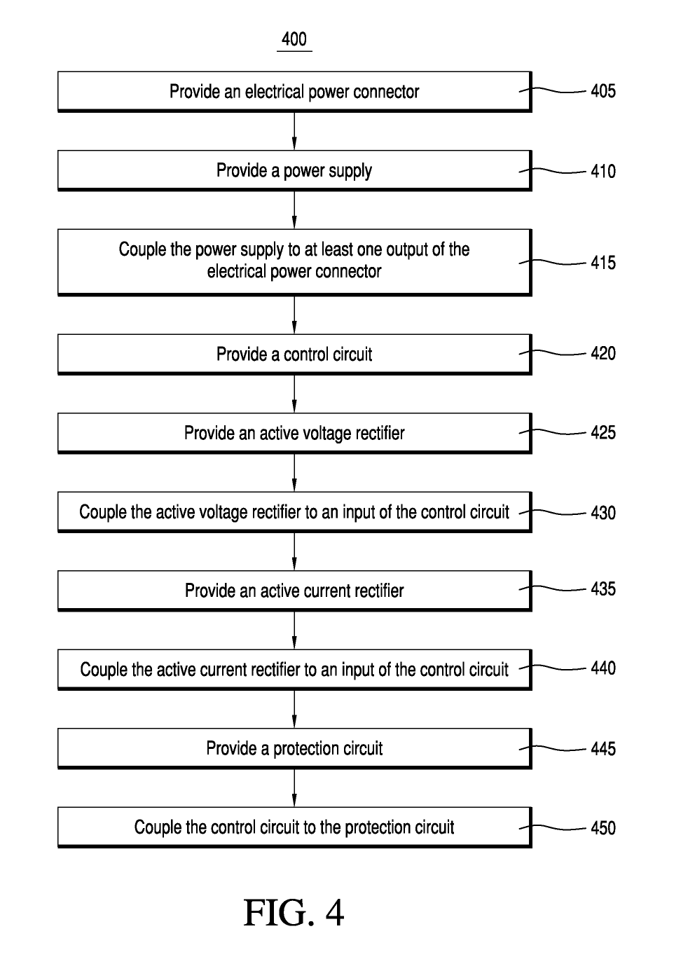

FIG. 4 illustrates a flow chart for an embodiment of a method 400 of providing an electrical device, according to the first embodiment. In some examples, the electrical device can be similar to or the same as electrical device 100 of FIGS. 1-3.

Method 400 is merely exemplary and is not limited to the embodiments presented herein. Method 400 can be employed in many different embodiments or examples not specifically depicted or described herein. In some embodiments, the activities, the procedures, and/or the processes of method 400 can be performed in the order presented. In other embodiments, the activities, the procedures, and/or the processes of the method 400 can be performed in any other suitable order. In still other embodiments, one or more of the activities, the procedures, and/or the processes in method 400 can be combined or skipped.

Referring to FIG. 4, method 400 includes an activity 405 of providing an electrical power connector. In some examples, the electrical power connector can be configured to receive an alternating current input power signal from an external power source. In some examples, the electrical power connector can be similar to or the same as electrical power plug 102 of FIG. 1.

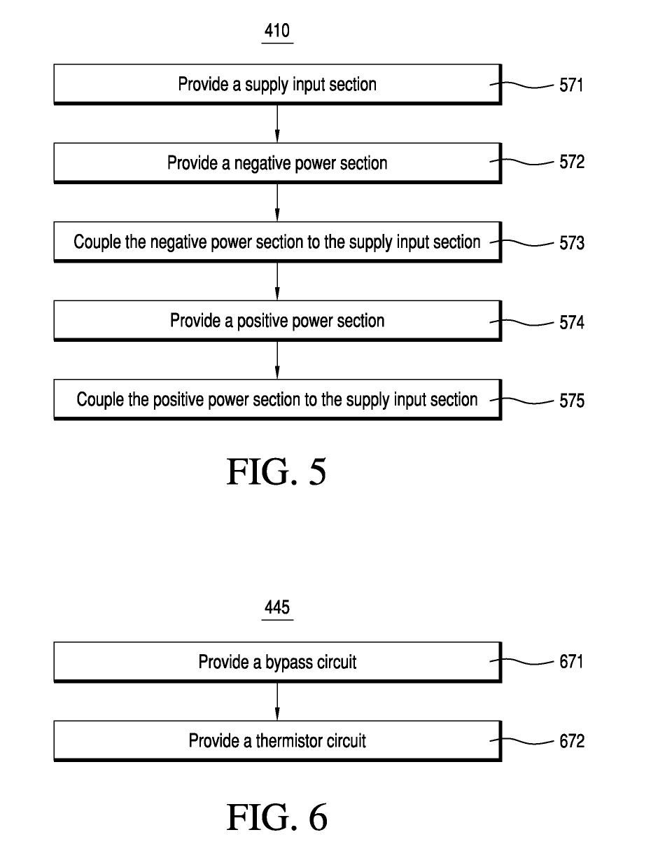

Method 400 in FIG. 4 continues with an activity 410 of providing a power supply. In some examples, the power supply can be configured to supply at least two direct current electrical power signals derived from the alternating current input power signal and referenced to the L2 line signal when the electrical power connector receives the alternating current input power signal from the external power source. In the same or different examples, the power supply can be devoid of a transformer and a switch. In various embodiments, the power supply can be similar to or the same as power supply 355 of FIG. 3. FIG. 5 illustrates a flow chart for an exemplary embodiment of activity 410 of providing a power supply, according to the first embodiment.

Referring to FIG. 5, activity 410 includes a procedure 571 of providing a supply input section that is configured receive an L1 line signal. In some examples, the supply input section can be similar or the same as supply input section 360 of FIG. 3.

Activity 410 in FIG. 5 continues with a procedure 572 of providing a negative power section. In some examples, the negative power section can be configured to receive the L2 line signal and to output a first output electrical power signal. In some examples, the negative power section can be similar or identical to negative power section 365 of FIG. 3.

Subsequently, activity 410 of FIG. 5 includes a procedure 573 of coupling the negative power section to the supply input section. In some examples, the coupling of the negative power section to the supply input section can be identical or similar to the coupling of negative power section 365 to supply input section 360 as shown in FIG. 3.

Next, activity 410 of FIG. 5 includes a procedure 574 of providing a positive power section. In some examples, the positive power section can be configured to receive the L2 line signal and to output a second output electrical power signal. In various embodiments, the positive power section can be similar to or the same as positive power section 370 of FIG. 3.

Referring to FIG. 5, activity 410 includes a procedure 575 of coupling the positive power section to the supply input section. In some examples, the coupling of the positive power section to the supply input section can be identical or similar to the coupling of positive power section 370 to supply input section 360 as shown in FIG. 3. After procedure 575, activity 410 is complete.

Referring back to FIG. 4, method 400 of FIG. 4 includes an activity 415 of coupling the power supply to at least one output of the electrical power connector. In some examples, the coupling the power supply to at least one output of the electrical power connector can be similar to or the same as the coupling of power supply 355 to line L1 and line L2, as shown in FIG. 3.

Next, method 400 of FIG. 4 includes an activity 420 of providing a control circuit. In various embodiments, the control circuit can receive electrical power from the power supply. In some examples, the control circuit can be similar to or the same as control circuit 375 of FIG. 3.

Method 400 in FIG. 4 continues with an activity 425 of providing an active voltage rectifier. In some examples, the active voltage rectifier can be similar to or the same as active voltage rectifier 380 of FIG. 3.

Subsequently, method 400 of FIG. 4 includes an activity 430 of coupling the active voltage rectifier to an input of the control circuit. In some embodiments, the active voltage rectifier is coupled to an input of the control circuit such that the active voltage rectifier can provide a first output signal to the input of the control circuit. In many examples, the coupling of the active voltage rectifier to an input of the control circuit can be similar to or the same as the coupling of active voltage rectifier 380 to an input (i.e., pin 3) of microcontroller 376.

Next, method 400 of FIG. 4 includes an activity 435 of providing an active current rectifier. In some examples, the active current rectifier can be similar to or the same as active current rectifier 385 of FIG. 3.

Method 400 in FIG. 4 continues with an activity 440 of coupling the active current rectifier to an input of the control circuit. In some embodiments, the active current rectifier is coupled to an input of the control circuit such that the active current rectifier can provide a second output signal to the input of the control circuit. In many examples, the coupling of the active current rectifier to an input of the control circuit can be similar to or the same as the coupling of active current rectifier 385 to an input (i.e., pin 10) of microcontroller 376.

Subsequently, method 400 of FIG. 4 includes an activity 445 of providing a protection circuit. FIG. 6 illustrates a flow chart for an exemplary embodiment of activity 445 of providing a protection circuit, according to the first embodiment.

Referring to FIG. 6, activity 445 includes a procedure 671 of providing a bypass circuit. In some examples, the bypass circuit can include at least one first relay. For example, the bypass circuit and the at least one first relay can be similar to or the same as bypass circuit 390 and relay 393, respectively, of FIG. 3.

Activity 445 in FIG. 6 continues with a procedure 672 of providing a thermistor circuit. In some examples, the thermistor circuit can include at least one second relay and a negative temperature coefficient thermistor in series with the at least one second relay. For example, the thermistor circuit, the at least one second relay, and the negative temperature coefficient thermistor can be similar to or the same as thermistor circuit 395, relay 399, and the negative temperature coefficient thermistor 396, respectively, of FIG. 3. After procedure 672, activity 445 is complete.

Referring again to FIG. 4, method 400 of FIG. 4 includes an activity 450 of coupling the control circuit to the protection circuit. In some examples, the control circuit is configured to determine one or more parameters of the alternating current input power signal based on the first output signal and the second output signal. The control circuit can be further configured to control the protection circuit based on the one or more parameters. In some examples, the coupling of the control circuit to the protection circuit can be similar to or the same as the coupling of control circuit 375 to the bypass circuit 390 and thermistor circuit 395 of FIG. 3.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 405, 410, 415, 420, 425, 430, 435, 440, 445, and 450 of FIG. 4, procedures 571-575 of FIG. 5, and procedures 671-672 of FIG. 6 may be comprised of many different activities, procedures and be performed by many different modules, in many different orders, that any element of FIGS. 1-3 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An electrical device comprising:
an electrical power input configured to receive an input electrical power signal, the input electrical power signal including a reference power line signal; and
a power supply configured to output at least two output electrical power signals, the at least two output electrical power signals being referenced to the reference power line signal,
wherein:
the power supply is devoid of a transformer;
the power supply is further devoid of a switch; and
the power supply is configured to receive the input electrical power signal and to derive the at least two output electrical power signals from the input electrical power signal by using capacitive reactance to limit a current of the input electrical power signal.

2. The electrical device of claim 1 wherein:
the power supply comprises:
a supply input section coupled to the electrical power input;
a negative power section electrically coupled to the supply input section and configured to receive the reference power line signal from the electrical power input, the negative power section being configured to output a first output electrical power signal; and
a positive power section electrically coupled to the supply input section and configured to receive the reference power line signal from the electrical power input, the positive power section being configured to output a second output electrical power signal;
the first output electrical power signal has a negative voltage relative to the reference power line signal;
the second output electrical power signal has a positive voltage relative to the reference power line signal; and
the at least two output electrical power signals comprise the first output electrical power signal and the second output electrical power signal.

3. The electrical device of claim 2 wherein:
the supply input section comprises:
a first capacitor configured to receive the input power signal;
one or more resistors in parallel with the capacitor; and
a fuse in series with the capacitor.

4. The electrical device of claim 2 wherein:
the negative power section comprises:
a first diode coupled to the supply input section;
one or more capacitors coupled to the first diode and configured to receive the reference power line signal; and
one or more second diodes in parallel with the one or more capacitors, the one or more second diodes being coupled to the first diode and configured to receive the reference power line signal.

5. The electrical device of claim 2 wherein:
the positive power section comprises:
a first diode coupled to the supply input section;
one or more capacitors coupled to the first diode and configured to receive the reference power line signal; and
one or more second diodes in parallel with the one or more capacitors, the one or more second diodes being coupled to the first diode and configured to receive the reference power line signal.

6. The electrical device of claim 1 wherein:
the reference power line signal is propagated on a neutral line.

7. The electrical device of claim 1 further comprising:
a microcontroller;
an active voltage rectifier;
an active current rectifier;
a thermistor circuit comprising one or more first relays; and
a bypass circuit comprising one or more second relays;
wherein:
the microcontroller is configured to receive (a) a first rectifier signal from the active voltage rectifier; and (b) a second rectifier signal from the active current rectifier, and the microcontroller is further configured to open and close the one or more first relays and the one or more second relays based on the first and second rectifier signals.

8. The electrical device of claim 7 wherein:
the thermistor circuit further comprises a negative temperature coefficient thermistor in series with the one or more first relays.

9. A relocatable power tap comprising:
an electrical power connector configured to receive an alternating current input power signal from an external power source, the alternating current input power signal comprising an L1 line signal and an L2 line signal;
a power supply configured to provide at least two direct current electrical power signals derived from the alternating current input power signal and referenced to the L2 line signal;
a control circuit;
an active voltage rectifier circuit;
an active current rectifier circuit; and
a protection circuit,
wherein:
the active voltage rectifier circuit and the active current rectifier circuit are configured to provide two or more output signals to the control circuit;
the control circuit is configured to determine one or more parameters of the alternating current input power signal based on the two or more output signals; and
the control circuit is further configured to control the protection circuit based on the one or more parameters.

10. The relocatable power tap of claim 9 wherein:
the protection circuit comprises:
a bypass circuit comprising at least one first relay; and
a thermistor circuit comprising at least one second relay and a negative temperature coefficient thermistor in series with the at least one second relay.

11. The relocatable power tap of claim 10 wherein:
the control circuit is electrically coupled to the at least one first relay of the bypass circuit and the at least one second relay of the thermistor circuit; and
the control circuit is further configured to open and close the at least one first relay of the bypass circuit and to open and close the at least one second relay of the thermistor circuit based on the one or more parameters.

12. The relocatable power tap of claim 9 wherein:
the power supply is devoid of a transformer; and
the power supply is further devoid of a switch.

13. The relocatable power tap of claim 9 wherein:
the power supply comprises:
a voltage divider with a reactive input configured to receive the L1 line signal and configured to derive the at least two direct current electrical power signals using the L2 line signal as a reference signal.

14. The relocatable power tap of claim 13, wherein:
the voltage divider comprises:
a first capacitor coupled to the L1 line signal;
a fuse coupled to the first capacitor in series,
at least two first diodes coupled to the fuse;
one or more second capacitors coupled to the at least two first diodes and configured to receive the L2 line signal; and
one or more second diodes in parallel with the one or more second capacitors, coupled to the at least two first diodes, and configured to receive the L2 line signal.

15. The relocatable power tap of claim 9 wherein:
the power supply is configured to output a first direct current electrical power signal of positive five volts with reference to the L2 line signal;
the power supply is configured to output a second direct current electrical power signal of negative five volts with reference to the L2 line signal; and
the at least two direct current electrical power signals comprise the first direct current electrical power signal and the second direct current electrical power signal.

16. The relocatable power tap of claim 9 wherein:
the active voltage rectifier circuit comprises one or more resistors; and
the one or more resistors form a voltage divider between a first line on which the L1 line signal is propagated and a second line on which the L2 line signal is propagated.

17. A method of providing an electrical device, the method comprising:
providing an electrical power connector configured to receive an alternating current input power signal from an external power source, the alternating current input power signal comprises an L1 line signal and an L2 line signal;
providing a power supply configured to supply at least two direct current electrical power signals derived from the alternating current input power signal and referenced to the L2 line signal;
coupling the power supply to at least one output of the electrical power connector;
providing a control circuit comprising a first input and a second input;
providing an active voltage rectifier circuit;
coupling the active voltage rectifier circuit to the first input of the control circuit such that the active voltage rectifier circuit can provide a first output signal to the first input of the control circuit;
providing an active current rectifier circuit;
coupling the active current rectifier circuit to the second input of the control circuit such that the active current rectifier circuit can provide a second output signal to the second input of the control circuit;
providing a protection circuit; and
coupling the control circuit to the protection circuit,
wherein:
the control circuit is configured to determine one or more parameters of the alternating current input power signal based on the first output signal and the second output signal;
the control circuit is further configured to control the protection circuit based on the one or more parameters; and
the power supply is configured to provide each of the at least two direct current electrical power signals to at least one of the control circuit, the active voltage rectifier circuit, the active current rectifier circuit, or the protection circuit.

18. The method of claim 17 wherein:
the power supply is devoid of a transformer; and
the power supply is further devoid of a switch.

19. The method of claim 17 wherein:
providing the power supply comprises:
providing a supply input section that is configured to receive the L1 line signal;
providing a negative power section that is configured to receive the L2 line signal and to output a first output electrical power signal;
coupling the negative power section to the supply input section;
providing a positive power section that is configured to receive the L2 line signal and to output a second output electrical power signal; and
coupling the positive power section to the supply input section,
the first output electrical power signal has a negative voltage relative to the L2 line signal;
the second output electrical power signal has a positive voltage relative to the L2 line signal; and
the at least two direct current electrical power signals comprise the first output electrical power signal and the second output electrical power signal.

20. The method of claim 17 wherein:
providing the protection circuit comprises:
providing a bypass circuit comprising at least one first relay; and
providing a thermistor circuit comprising at least one second relay and a negative temperature coefficient thermistor in series with the at least one second relay.
